(19) United States
(12) Patent Application Publication
(10) Pub. No.: US 2003/0138022 A1
(43) Pub. Date: Jul. 24, 2003

(54) Method of manufacturing helicoidal mirrors and distributed feedback elements

(75) Inventor: Tigran Galstian, Ste Foy (CA)

Correspondence Address: OGILVY RENAULT, 1981 MCGILL COLLEGE AVENUE, SUITE 1600, MONTREAL, QC, H3A2Y3, CA

(73) Assignee: Universite Laval, Quebec City (CA)

(21) Appl. No.: 10/341,581

(22) Filed: Jan. 14, 2003

Related U.S. Application Data
(60) Provisional application No. 60/347,258, filed on Jan. 14, 2002.

(51) Int. Cl. H01S 3/08

(52) U.S. Cl. 372/96; 372/99

(57) ABSTRACT

A solid-state optical device supports a Helicoidal Standing Wave along an optical axis of the device. A holographic recording technique utilizes the Weigert effect to generate a spatially rotating axis of optical anisotropy in a longitudinal direction of the optical axis. As a result, a Helicoidal Standing Wave propagating in a direction of the optical axis, and having a wavelength substantially corresponding to a period of the helix, is supported by the optical device.

### CROSS-REFERENCE TO RELATED APPLICATIONS

This application is based on, and claims priority under 37 USC §119(e) of U.S. patent application Ser. No. 60/347,258 filed Jan. 14, 2002.

### MICROFICHE APPENDIX

Not Applicable.

### TECHNICAL FIELD

The present invention relates to the field of optical devices, and more particularly to lasers.

### BACKGROUND OF THE INVENTION

As shown in FIG. 1a, a conventional laser resonator 2 comprises an “active” or amplifying material 4 disposed within a cavity between a pair of plain mirrors 6. Typically, conventional laser resonators are anisotropic (containing, for example, Brewster angles). Such resonators support linearly or quasi-linearly polarized laser modes. The Standing Waves (SW) corresponding to these modes have a spatially non-uniform intensity distribution in the active medium, as shown in FIG. 1b. This leads to spatially non-uniform gain saturation, which allows the simultaneous generation of multiple longitudinal modes, thereby reducing the laser coherence. The number of modes supported by conventional laser resonators may be up to 10³ for Ruby lasers and 10⁴ for YAG lasers.

Helicoidal Standing Waves (HSW) have been proposed to overcome this problem. Such an HSW may be created by means of two counter propagating circularly polarized beams having the same circularity, as shown in FIG. 2a. In the example of FIG. 2a, E⁺⁺ is a right circularly polarized beam, having wavevector K⁺⁺, which propagates in +z direction. E⁺⁻ is a right circularly polarized beam, having wavevector K⁺⁻, which propagates in the −z direction. The electric vector (E) of the resultant HSW is spatially rotating and has no nodes, which creates a spatially uniform optical intensity distribution within the active medium of the laser resonator, as shown in FIG. 2c. This allows a single longitudinal mode operation of the laser resonator. In order to obtain an HSW within the active medium, a pair of quarter-wave plates 8 can be introduced into the laser resonator, as shown in FIG. 2b. This is costly and often extremely difficult to implement (for example in distributed feedback or micro gravity lasers).

The required HSW may also be obtained by means of Cholesteric Liquid Crystal (CLC) mirrors. The CLC is a liquid crystal material having a spatially rotating optical anisotropy axis. This rotation is the result of the microscopic chiral character of its molecules. In fact, this may be referred to as a Helicoidal Bragg Grating (HBG). This grating reflects only light having a wavelength λc that satisfies the Bragg condition, and having a circularity of the same helicity as the HBG. Light having the opposed circularity is transmitted through the HBG without significant losses. Another peculiarity of such a helicoidal mirror is the fact that it does not change the circularity sign of the reflected beam. Thus, using such mirrors we obtain a feedback, where the supported modes are counter propagating circularly polarized beams of the same circularity, forming the HSW. This may be called a Helicoidal Mirror Resonator (HMR). As with the use of solid quarter-wave plates, CLC-mirrors can be costly and difficult to implement. In addition, the use of liquid crystals in such applications raises issues related to the stability of the device under varying conditions of operation.

Accordingly, a cost-effective device capable of supporting Helicoidal Standing Waves, remains highly desirable.

### SUMMARY OF THE INVENTION

An object of the present invention is to provide a cost-effective device capable of supporting Helicoidal Standing Waves, and methods for making same.

Accordingly, an aspect of the present invention provides a solid-state optical device for supporting a Helicoidal Standing Wave. The optical device comprises an optical axis, and an axis of optical anisotropy oriented substantially perpendicular to the optical axis. The axis of optical anisotropy spatially rotates to define a helix of optical anisotropy in a longitudinal direction of the optical axis. As a result, a Helicoidal Standing Wave propagating in a direction of the optical axis, and having a wavelength substantially corresponding to a period of the helix, is supported by the optical device.

A further aspect of the present invention provides a method of making a solid-state optical device for supporting a Helicoidal Standing Wave. According to the present invention, a coherent pair optical beams is generated, each beam having a respective predetermined polarization. The two beams are caused to converge and generate an interference pattern within a solid material. The interference pattern having a spatially rotating e-field in a longitudinal direction of a predetermined optical axis. As a result, the interference pattern induces a helix of optical anisotropy within the solid material, in accordance with the spatially rotating e-field.

Thus the present invention provides an optical device (which may be used as a solid helicoidal mirror—SHM) capable of supporting Helicoidal Standing Waves, and methods of making same. Using the methods of the present invention, a solid helicoidal mirror (SHM) can be fabricated within any of a wide variety of known materials, without any limitation on its size and aperture, etc. This is based on a holographic recording technique which is easy to produce industrially. It does not require additional costly materials or processing. The SHM will allow the fabrication of narrow band single longitudinal mode lasers (including in the infrared band) and helicoidal distributed feedback systems for applications in communications, optoelectronics, spectroscopy, optical activity detection, precision measurements, etc.

### BRIEF DESCRIPTION OF THE DRAWINGS

Further features and advantages of the present invention will become apparent from the following detailed description, taken in combination with the appended drawings, in which:

FIGS. 1a and 1b respectively illustrate principle elements of a conventional laser resonator, and an optical intensity distribution of standing waves within the active medium of the resonator;

FIGS. 2a-c respectively illustrate counter propagating circularly polarized beams forming an helicoidal standing wave (HSW), principle elements of a conventional laser resonator adapted to support an HSW, and an optical intensity distribution of an HSW within the active medium of the resonator;

FIGS. 3a and 3b respectively illustrate linearly and circularly polarized beams;

FIG. 4 schematically illustrates spatially rotating E-field; and

FIG. 5 schematically illustrates formation of a spatially rotating optical anisotropy axis in a small aperture medium, in accordance with a second embodiment of the present invention.

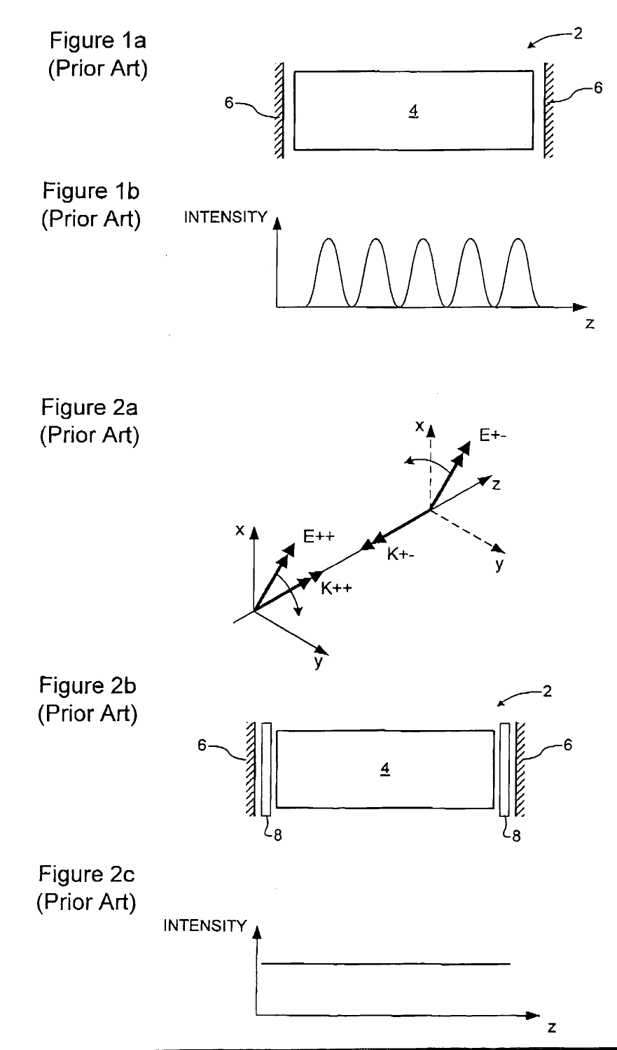

It will be noted that throughout the appended drawings, like features are identified by like reference numerals.

### DETAILED DESCRIPTION OF THE PREFERRED EMBODIMENT

The present invention provides a solid-state device having a spatially rotating (i.e., helical) optical anisotropy axis, and methods for creating such a device using a wide variety of known materials. The device of the present invention can be used as a solid helicoidal mirror (SHM), for supporting a helicoidal standing wave within the cavity of a laser resonator. Several new kinds of optical and electro-optical devices can also be fabricated using the device and methods of the present invention.

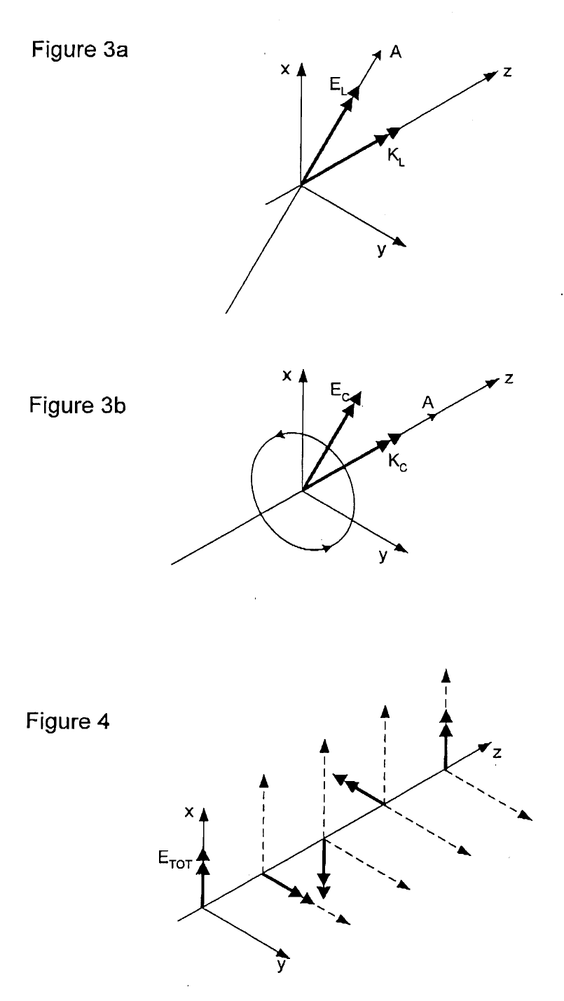

As is known in the art, the Weigert Effect (WE) is a phenomenon in which optical anisotropy is induced in polarization-sensitive materials by irradiation with polarized light. For linearly polarized light E_{L}, the induced anisotropy axis A is directed parallel with the polarization state, as may be seen in FIG. 3a. For non-polarized or circularly polarized light, E_{c}, the induced anisotropy axis A is parallel with the wave vector K (that is, parallel with the z-axis in FIG. 3b).

The Weigert effect can be used to induce optical anisotropy in a wide variety of laser-active or laser-passive media, directly or after doping. Many available materials, such as doped polymers, glasses and semiconductors already possess are sensitive to induction of optical anisotropy in this manner. For the purposes of the present application, these materials are collectively referred to as Weigert Materials (WM).

In accordance with the present invention, polarization holography is used to induce a spatially rotating optical anisotropy axis A along a predetermined optical axis (z). In general, a pair of coherent beams having different polarization states are combined in such a manner as to generate a helicoidal standing wave in which the E-field component rotates spatially along the length the desired optical axis, as may be seen in FIG. 4. This arrangement induces a corresponding spatially rotating optical anisotropy within a Weigert Material, which can then be used to as a solid helicoidal mirror (SHM) having optical properties similar to that of a Cholesteric Liquid Crystal (CLC) mirror.

Various methods may be used to create the spatially rotating optical anisotropy axis A in accordance with the present invention. For the purposes of illustration, two methods are presented below, each of which is particularly suited to a respective different aperture size of an SHM manufactured using the method of the present invention.

### Example 1

### Large Aperture” SHM

In order to generate a Large Aperture SHM, a pair of counter-propagating circularly polarized beams having the same circularity (see FIG. 2a), are generated and used to establish an interference pattern having a total e-field that spatially rotates in a longitudinal direction of the optical axis (in the illustrated embodiments, the optical axis is parallel to the z-axis) within a bulk Weigert material. The helix of the interference pattern electric field is thus recorded via the Weigert effect in the Weigert material as the desired helix of optical anisotropy (See FIG. 4).

The wavelength λR used to record the helical optical anisotropy within the Weigert material corresponds to λC (where λC is the “working” or the “central” wavelength to be reflected by the SHM) to satisfy the Bragg condition. In particular, for a desired λC, it is necessary to select a Wieger material for which the spectral band of sensitivity to the Weigert effect is situated near λC, taking into account the dispersion of the material used. A real-time or post exposure fixing (or memory effect) of the material chose is also required to prevent the erasure of the SHM during its utilization.

In some cases, a “two photon” recording technique can be used to extend the range of wavelengths that can be supported by a chosen Weigert Material. In general, the “two photon” recording technique utilizes a powerful laser having a wavelength λR, (where the λR/2 is in the Weigert effect photosensitivity band) to record the helix of optical anisotropy. For example, a powerful pulsed Nd:YAG laser operating at λR=1064 nm can be used to record a helix of optical anisotropy within a doped glass As₂S₃ (which has a Weigert effect sensitivity band near λR/2=532 nm). The resulting SHM may then be used with a low power YAG laser having a center wavelength (CW) of 1064 nm.

Large aperture SHM devices may be used in various ways. For example, a pair of SHMs may be used as passive external mirrors to create a helicoidal mirror resonator. An active (or amplifying) medium disposed between the two SHMs will convert the helicoidal mirror resonator into a single longitudinal mode laser resonator having a narrow band emission. Alternatively, the helix of optical anisotropy can be directly recorded in the active medium of the laser resonator, to thereby allow the fabrication of an Active SHM (ASHM) or, as one could call it, a Helicoidal Distributed Feedback Laser (HDFBL).

In a further alternative, a single SHM may be used as a passive or active element for polarization shaping. For example, for imparting a circular polarization to initially non-polarized light. Furthermore, a SHM could be used as an element with very large coefficient of polarization rotation (the optical activity coefficient in CLC is 104 times stronger than in optically active isotropic liquids) for various optical and electro-optic applications.

### Example 2

### “Small Aperture” SHM

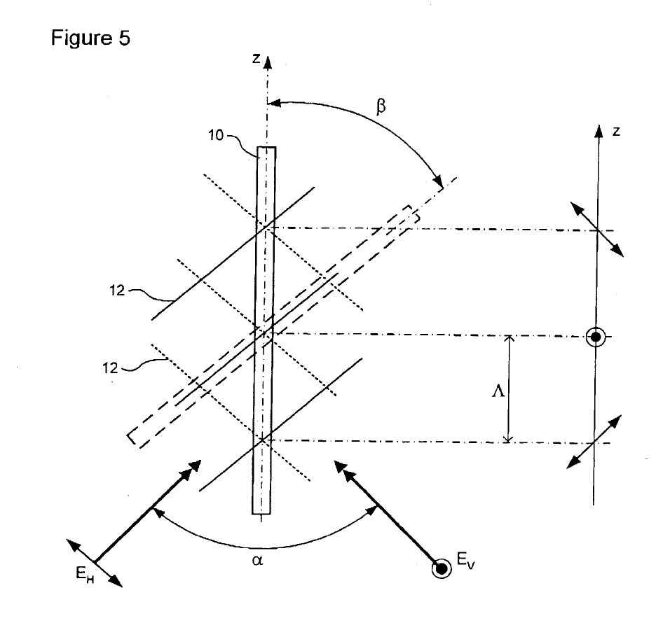

In order to generate a Small Aperture SHM, a relatively thin optical element 10 (composed of a Weigert material) is used, in order to avoid coupling of λC with λR, and therefore provide some freedom in the selection of λR. In this case, a pair of orthogonally polarized beams, E_{V} and E_{H} are made to converge at an angle α, as shown in FIG. 5. As the two beams converge, interfering wave-fronts 12 of the beams form a stationary interference pattern in which the total E-field is periodically modulated in space to form the desired helix, as shown in the right-hand side of FIG. 5. By placing the thin Weigert material 10 at a desired angle β within the interference pattern, a “grating” having a helix of optical anisotropy, and a period Λ, is recorded in the Weigert material 10. The grating period Λ is determined by the convergence angle α, and the orientation angle β of the Weigert material. As may be appreciated, this arrangement allows the grating to be constructed with virtually any desired period Λ (equal to or greater than λR). Since the working or center wavelength λC of the resulting SHM corresponds to the grating period Λ, the desired λC can be obtained substantially independently of λR (and, the Weigert effect sensitivity band). The ratio R=A/Λ of the SHM aperture A to the desired grating period Λ defines the aperture size of the SHM.

This technique may be used for the creation of Thin Helicoidal Distributed Feedback (THDFB) elements in guiding systems (e.g. fibers or waveguides) for light generation, guiding or modulation. The same Weigert effect may be used to create and control the average anisotropy of these elements at desired levels to support the optimal work of the THDFB, if necessary. For example, a Weigert material may be used as a core or a cladding (or substrate) material for a guiding element. Its uniform exposition by means of a light beam will create (via the Weigert effect) identical conditions for TE and TM modes. The orientation of the electrical field of the recording beam (in the linear polarization case) or its wave vector (in the case of a circular polarized or non-polarized recording beam) will define the created anisotropy axis. Thus, we can obtain guiding elements with controlled anisotropy. The further exposure of the obtained element by means of two orthogonally polarized beams will record the desired THDFB. Here also, the long term memory of the Weigert material is a necessary condition for high figure of merit of the THDFB.

In some cases, reversibility of the Weigert effect may be useful and quite produceable, but special precautions must be taken (e.g. continuous recording or refreshing) to conserve the quality of the SHM during its utilization. The real-time formation of a SHM using pumping (recording) beams having a wavelength λR=λC may be produceable and also very useful. The SHM may be called Dynamic Helicoidal Distributed Feedback (DHDFB) Systems. In addition, the reversibility will allow the SHM to be reconfigurable.

Small aperture and dynamic SHMs can be used in various ways. For example, a THDFB may be used as an integrated TE/TM polarization insensitive, but phase sensitive, filter (i.e., a filter that reflects both TE and TM modes equally, but only the combined TE/TM modes with a given phase shift, that is, circularity). The same operations may be done with selective amplification and light generation if some active “dopants” are present in the system.

In addition to the applications noted above, the DHDFB represents itself a separate interest as an integrated laser system.

Other applications, similar to that of a large aperture SHM may also be provided.

The embodiments) of the invention described above is(are) intended to be exemplary only. The scope of the invention is therefore intended to be limited solely by the scope of the appended claims.

I claim:

1. A solid-state optical device for supporting a Helicoidal Standing Wave, the optical device comprising:
an optical axis; and
an axis of optical anisotropy oriented substantially perpendicular to the optical axis and spatially rotating to define a helix of optical anisotropy in a longitudinal direction of the optical axis;
wherein a Helicoidal Standing Wave propagating in a direction of the optical axis, and having a wavelength substantially corresponding to a period of the helix, is supported by the optical device.

2. An optical device as claimed in claim 1, wherein the device is composed of a solid material that is susceptible to an induced optical anisotropy in response to exposure to polarized light.

3. A method of making a solid-state optical device for supporting a Helicoidal Standing Wave, the method comprising steps of: generating a coherent pair optical beams, each beam having a respective predetermined polarization;
causing the two beams to converge and generate an interference pattern within a solid material, the interference pattern having a spatially rotating e-field in a longitudinal direction of a predetermined optical axis;
wherein the interference pattern induces a helix of optical anisotropy within the solid material, in accordance with the spatially rotating e-field.

4. A method as claimed in claim 3, wherein the step of generating a coherent pair optical beams comprises a step of generating a pair of circularly polarized beams having a common wavelength and circularity.

5. A method as claimed in claim 4, wherein the step of causing the two beams to converge comprises a step of directing the two beams to counter-propagate parallel to the predetermined optical axis.

6. A method as claimed in claim 5, wherein a period of the helix of optical anisotropy within the solid material substantially corresponds with the wavelength of the two light beams.

7. A method as claimed in claim 3, wherein the step of generating a coherent pair optical beams comprises a step of generating a pair of linearly polarized beams having a common wavelength and orthogonal polarization.

8. A method as claimed in claim 7, wherein the step of causing the two beams to converge comprises a step of directing the two beams to converge at a predetermined convergence angle a of less than 180 degrees.

9. A method as claimed in claim 8, wherein a period of the helix of optical anisotropy within the solid material is a function of the convergence angle α.
